(19) United States
(12) Patent Application Publication
(10) Pub. No.: US 2017/0168685 A1
(43) Pub. Date: Jun. 15, 2017

(54) METHOD AND ELECTRONIC DEVICE FOR CONTROLLING TERMINAL WINDOW DISPLAY

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Junwei LIU, Beijing (CN)

(21) Appl. No.: 15/243,127

(22) Filed: Aug. 22, 2016

Related U.S. Application Data
(63) Continuation of application No. PCT/CN2016/088622, filed on Jul. 5, 2016.

(30) Foreign Application Priority Data
Dec. 15, 2015 (CN) 201510938025.0

(51) Int. Cl. G06F 3/0484; G06F 3/0482

(52) U.S. Cl. CPC G06F 3/04845; G06F 3/0482

(57) ABSTRACT

Embodiments of this application discloses a method and an electronic device for controlling terminal window display, the controlling method includes: receiving an instruction to open the display window input by the user; and controlling the display window to be displayed in a floating manner according to a preset display size that is smaller than a size of the terminal screen, according to the instruction to open the display window.

### CROSS-REFERENCES TO RELATED APPLICATIONS

This application is a continuation of International Application No. PCT/CN2016/088622, filed on Jul. 5, 2016, which is based upon and claims priority to Chinese Patent Application No. 201510938025.0, filed on Dec. 15, 2015, the entire contents of which are incorporated herein by reference.

### TECHNICAL FIELD

This application relates to intelligent terminal display technology, for example, to a method and an electronic device for controlling terminal window display.

### BACKGROUND

With the rapid development of intelligent terminals, the screen size of the intelligent terminals is getting larger and larger, mostly is on the order of 5 or 6 inches. Although the intelligent terminal with a large-size screen gives a user better display experience, it may have a drawback of difficulty in one-handed operation.

Taking viewing an E-mail on the intelligent terminal as an example, first, a user selects a mail list item to be viewed in the mail list, enters a mail display window to view mail details after clicking the mail list item, and then returns to the mail list only by clicking a return key provided above (or at the bottom of) the mail display window, subsequently, views other mails through the same steps. If it is necessary to edit the mail, the user needs to click an editing key provided above the mail display window, to allow the display window to display an operating column which is mostly provided at the bottom of the window, and the user can edit the mail by operating the operating column which is at the bottom.

In the process of developing this application, the inventors find at least the following problems in the prior art: in a case that the intelligent terminals are mostly with large-size screens, users need to have the finger stay in the center of the screen to click a list item when viewing or editing contents of a mail or a short message, and the finger needs to move to the topmost or the bottommost of the large screen while returning to the list or operating, therefore, the operating procedure is highly laborious.

### SUMMARY

This application provides a method and an electronic device for controlling terminal window display, so as to improve a display manner of the display window of an intelligent terminal.

In a first aspect, embodiments of this application provide a method for controlling terminal window display, which includes:

at an electronic device:

receiving an instruction to open a display window; and

controlling the display window to be displayed in a floating manner according to a preset display size that is smaller than a size of the terminal screen, according to the instruction to open the display window.

In a second aspect, embodiments of this application also provide an electronic device for controlling terminal window display, which includes:

at least one processor; and

a memory communicably connected with the at least one processor for storing instructions executable by the at least one processor, wherein execution of the instructions by the at least one processor causes the at least one processor to:

receive an instruction to open a display window; and

control the display window to be displayed in a floating manner according to a preset display size that is smaller than a size of the terminal screen, according to the instruction to open the display window.

In a third aspect, embodiments of this application also provide a non-transitory computer-readable storage medium storing executable instructions that, when executed by electronic device, cause the electronic device for controlling terminal window display to:

receive an instruction to open a display window; and

control the display window to be displayed in a floating manner according to a preset display size that is smaller than a size of the terminal screen, according to the instruction to open the display window.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for controlling terminal window display according to Embodiment 1 of this application;

FIG. 2A to FIG. 2E are display schematic diagrams of a display window according to Embodiment 1 of this application;

FIG. 3 is a flowchart of a method for controlling terminal window display according to Embodiment 2 of this application;

FIG. 4A is a flowchart of a method for controlling terminal window display according to Embodiment 3 of this application;

FIG. 4B is a display schematic diagram of a mail display window according to Embodiment 3 of this application;

FIG. 5 is a schematic diagram of an electronic device for controlling terminal window display according to Embodiment 4 of this application; and

FIG. 6 is a hardware structural schematic diagram of a device for performing a method for controlling terminal window display according to Embodiment 6 of this application.

### DETAILED DESCRIPTION

In order to make the purposes, technical solutions and advantages of the embodiments of this application clearer, the technical solutions in the embodiments of this application will be clearly and completely described hereinafter according to the accompanying drawings of this application. Obviously, those embodiments described here are not all but only a part of embodiments of this application.

### Embodiment 1

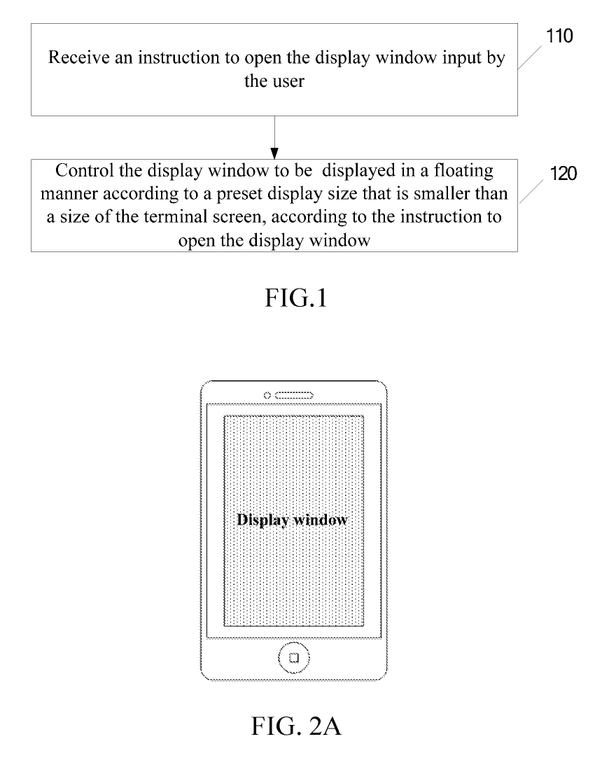

As shown in FIG. 1, which is a flowchart of a method for controlling terminal window display according to Embodiment 1 of this application, the technical solutions in this embodiment is applicable to a case that operational laboriousness of the intelligent terminal with a large-sized screen can be alleviated, by zooming the display window of the terminal. The method can be performed by an electronic device for controlling terminal window display, and the electronic device can be configured in an intelligent terminal.

The method for controlling terminal window display according to this embodiment includes steps as follows.

In S110, an instruction to open the display window input by the user is received.

As described above, all the operation parts of the terminal are window operations, and the user can perform operations explicitly and obtain operational results intuitively through the display window. If the user clicks a mailbox icon on the terminal interface, then a mailbox list display window is opened, and the user performs operations, such as viewing or editing in the display window. When the user clicks a mailbox entry in the mailbox list, then the display window of the entry is opened, and the user performs operations in the display window, such as viewing or editing content details of the entry, and editing the mail.

In the above operations, the display window refers to any one of the display windows on the terminal interface. The user clicks an entry, a list or an icon to be opened, so that the terminal can receive an instruction to open the display window input by the user.

In S120, the display window is controlled to be displayed in a floating manner according to a preset display size that is smaller than a size of the terminal screen, according to the instruction to open the display window.

As described above, after receiving the instruction to open the display window input by the user, the terminal controls corresponding display window to be opened according to the opening instruction. In particular, the terminal controls the opened display window to be displayed in a floating manner, the display size of the display window is a preset display size, and the preset display size is smaller than the size of the terminal screen. The user can set the size of any opened display window on the terminal interface to the preset display size, or can set the size of only the list item display window and/or an entry display window to the preset display size. The preset display size also can be set by the user, for example, the preset display size is set to be 70% of the main screen size.

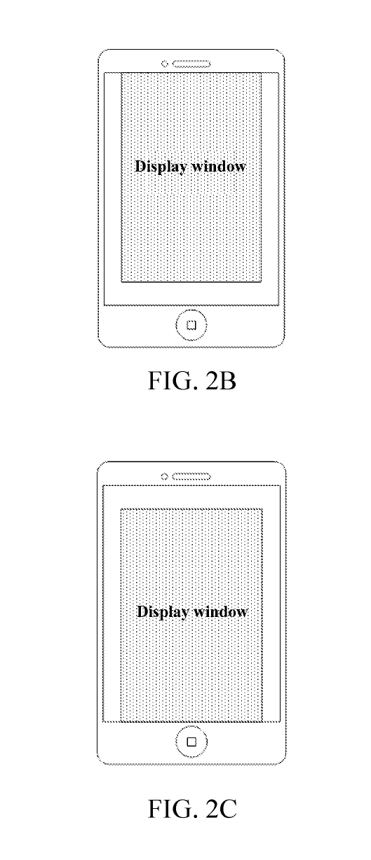

On the basis of the above technical solutions, controlling the display window to be displayed in a floating manner according to the preset display size that is smaller than the size of the terminal screen, according to the instruction to open the display window may include: as shown in FIG. 2A, controlling the display window to be displayed in the center of the terminal screen in the floating manner according to the preset display size that is smaller than the size of the terminal screen. Optionally, as shown in FIG. 2B or FIG. 2C, the display window is controlled to be displayed adjacent to an upper edge or a lower edge of the terminal screen in a floating manner according to the preset display size that is smaller than the size of the terminal screen. As shown in FIG. 2D and FIG. 2E, the display window is controlled to be displayed adjacent to a left edge or a right edge of the terminal screen in a floating manner according to the preset display size that is smaller than the size of the terminal screen.

The display area of the display window may also be the upper right corner and the lower left corner of the screen, or the like. Various display areas of the display window can be set in the terminal, so that the user can select the display area of the display window according to usage habits.

On the basis of the above technical solutions, the controlling method also may include: controlling the floatingly displayed window to move along a drag path, according to a drag operation instruction of the user to the display window. Here, the user's finger or a touch tool long-presses the display window and moves on the screen, the display window moves along a moving direction of the finger or the touch tool. After the user's finger or the touch tool leaves the screen, the display window is dragged to a leaving area of the user's finger or the touch tool.

After dragging of the user, some areas of the display window may exceed the range of the screen, then only the remaining area of the display window displays on the screen. The draggable feature of the display window allows the user to operate easily. For example, when an editing button of the display window is located on the upper right corner of the display window, a left-handed user can drag the display window to the left of the lower left corner of the screen according to a habit of the user, to facilitate the left hand to click the editing button, and thereby, a one-handed editing operation of the display window can be achieved.

By adopting the method for controlling terminal window display provided in Embodiment 1 of this application, after receiving an instruction to open the display window input by the user, the display window is controlled to be displayed in a floating manner according to a preset display size that is smaller than the size of the terminal screen, according to the instruction to open the display window. It can be seen that, a small-sized display window provides more operational convenience for the user, when the user views or operates the display window, for example, when the operating column of the display window is located at the top or the bottom of the display window, or the return button for returning to a previous display window is provided on the top or the bottom of the display window, compared with the related art, this embodiment has the advantages in that applications in the terminal can be operated without moving the finger to the topmost of the terminal screen, therefore, the operating procedure is easy, and user experience is improved.

### Embodiment 2

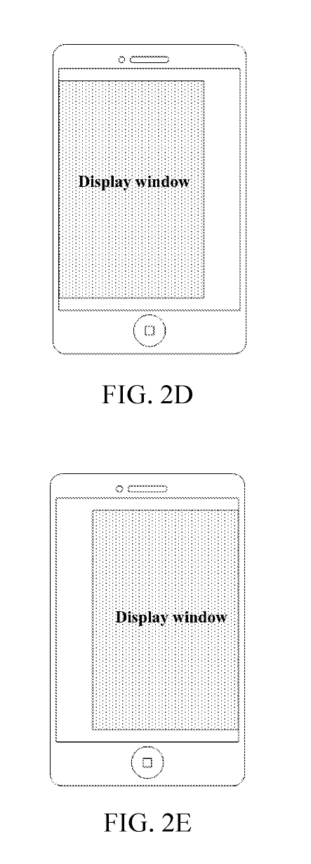

As shown in FIG. 3, which is a flowchart of a method for controlling terminal window display according to Embodiment 2 of this application, the technical solutions in this embodiment is applicable to a case that operational laboriousness of intelligent terminal with the large-sized screen can be alleviated, by zooming the display window of the terminal. The method can be performed by an electronic device for controlling terminal window display, and the electronic device can be configured in an intelligent terminal.

The method for controlling terminal window display according to this embodiment includes steps as follows.

In S210, an instruction to open the display window input by the user is received.

In the above operations, the display window can be any one of the display windows on the terminal interface, the user clicks an entry, a list or an icon to be opened, so that the terminal can receive an instruction to open the display window input by the user.

In S220, the display window is controlled to be displayed in a floating manner according to the preset display size that is smaller than a size of the terminal screen, according to the instruction to open the display window.

As described above, the preset display size can be set by the user, for example, the preset display size is set to be 70% of the main screen size, or a preset display size defaulted by the terminal, for example, the preset display size defaulted by the terminal is set to be 75% of the main screen size.

Optionally, controlling the display window to be displayed in a floating manner according to a preset display size that is smaller than a size of the terminal screen, according to the instruction to open the display window includes: controlling the display window to be displayed in the center of the terminal screen in a floating manner according to the preset display size that is smaller than the size of the terminal screen.

In S230, the display window is controlled to be closed, according to a triggering instruction input in a screen area other than the display window.

As described above, it is known that the display window displays according to the preset display size, and the preset display size is smaller than the size of the terminal screen, then after viewing the window, the display window is controlled to be closed, according to a triggering instruction input by the user in a screen area other than the display window. Here, the screen area other than the display window of the terminal displays a gray area and the gray area is set to trigger the closing operation, then a clicking operation of the user at any point of the gray area of the screen can control the display window to be closed, therefore, the operation is convenient, and user experience is improved.

Before opening the display window, the display size of the previous window of the display window may be the preset display size or the size of the terminal screen, then the closing operation triggered in the gray area other than the display window of the terminal screen can be the operation returning to the previous window, that is, if the user clicks at any point in the gray area of the screen, the display window is closed and the terminal screen displays the previous window of the display window. Optionally, after the display window is closed, the terminal screen displays in consistent with the display window prior to be opened, which facilitates the user to operate the previous display window.

By adopting the method for controlling terminal window display according to Embodiment 2 of this application, after receiving the instruction to open the display window input by the user, the display window is controlled to be displayed in a floating manner according to a preset display size that is smaller than the size of the terminal screen, according to the instruction to open the display window. After the window is viewed, the display window is controlled to be closed, according to a triggering instruction input by the user in a screen area other than the display window. The small-sized display window in this embodiment allows the user to operate more conveniently, the display window can be closed by receiving the triggering instruction input by the user in a screen area other than the display window, so that operations of viewing the window, editing the window and closing the window are convenient, compared with the related art, the finger doesn't need to move in a large range, the operation is convenient, and user experience is improved.

### Embodiment 3

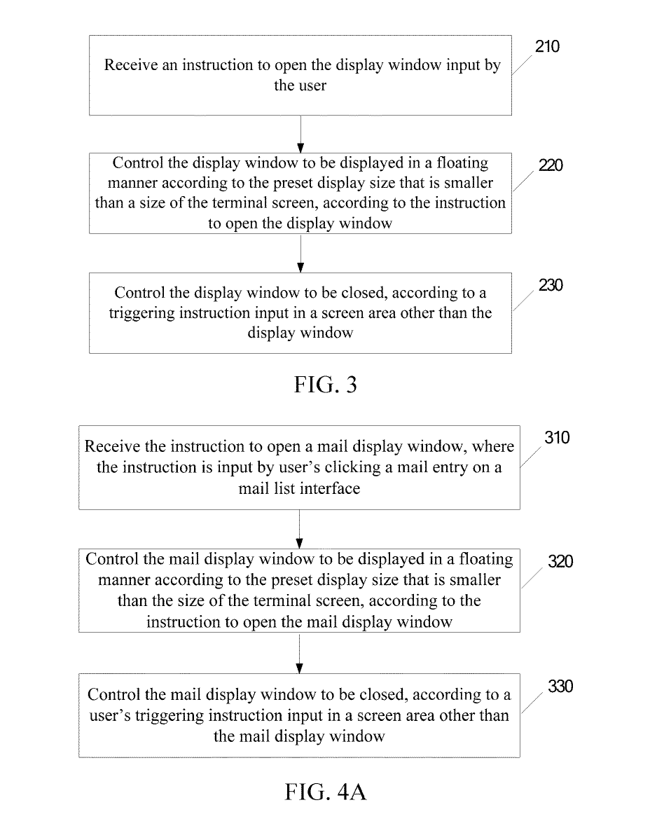

As shown in FIG. 4A, which is a flowchart of a method for controlling terminal window display according to Embodiment 3 of this application, the technical solutions in this embodiment is applicable to a case that operational laboriousness can be alleviated when viewing or editing mails on the large-sized screen intelligent terminal, by zooming the mail display window of the terminal. The method can be performed by an electronic device for controlling terminal window display, and the electronic device can be configured in an intelligent terminal.

The method for controlling terminal window display according to this embodiment includes steps as follows.

In S310, the instruction to open a mail display window is received, where the instruction is input by user's clicking a mail entry on a mail list interface.

As described above, there are pluralities of mail entries on the mail list interface, the user can search the mail entry to be viewed by sliding the mail list interface. When the mail entry to be viewed is found, after a double click or a single click on the mail entry by the user, the terminal receives the instruction to open a mail display window, where the instruction is input by user's clicking the mail entry on the mail list interface, and the mail corresponding to the mail entry is controlled to be opened and displayed, according to the mail display window instruction. Here, the display size of the mail list interface is the size of the terminal screen.

In S320, the mail display window is controlled to be displayed in a floating manner according to the preset display size that is smaller than the size of the terminal screen, according to the instruction to open the mail display window.

As described above, the preset display size is set to be 70% of the size of the terminal screen, then the mail display window displays in a floating manner according to 70% of the size of the terminal screen. The mail display window displays above the mail list interface in a floating manner, the mail list interface other than the mail display window is a gray area, therefore, regional comparison between the mail display window and the gray area can be formed, which facilitates the user to operate accurately on different areas. After the mail display window is opened, the user can view mail details by sliding operations within the range of the mail display window, and edit the mail through the operating column.

On the basis of the above technical solutions, the display manner of the mail display window in this embodiment is as shown in FIG. 4B, where the mail display window can be displayed in the center of the terminal screen in a floating manner according to 70% of the size of the terminal screen.

In S330, the mail display window is controlled to be closed, according to a user's triggering instruction input in a screen area other than the mail display window.

As described above, returning to the mail list interface after closing the mail display window, the mail can continue to be viewed or other operations can be performed. Here, the user can perform operations, such as double-click, single-click, moving downwards/upwards on the screen area other than the mail display window. The above operations can act as an input triggering instruction, and the terminal controls the mail display window to be closed, according to the triggering instruction. If a closing button is provided on the mail display window, then the mail display window can be closed by directly clicking the closing button, and the manner of closing the mail display window includes, but is not limited to those described above.

On the basis of the above technical solutions, after controlling the display window to be displayed in a floating manner according to the preset display size that is smaller than the size of the terminal screen, according to the instruction to open the mail display window, the method for controlling terminal window display further includes: controlling the floatingly displayed window to move along a drag path, according to a drag operation instruction to the display window.

By adopting the method for controlling terminal window display according to Embodiment 3 of this application, the mail display window instruction is input by the user's clicking the mail entry on the mail list interface. The display window is controlled to be displayed in a floating manner on the mail list interface, and the display size of the display window is smaller than the size of the terminal screen. The user can close the mail display window and return to the mail list interface by clicking the gray area other than the mail display window. In this embodiment, operations of the user's viewing the mail and returning to the mail list interface are very convenient, the user's operation is labor-saving, even when the user uses an intelligent terminal with a large-sized screen, viewing the mail with one-hand is also convenient, and the finger doesn't need to move in a wide range.

### Embodiment 4

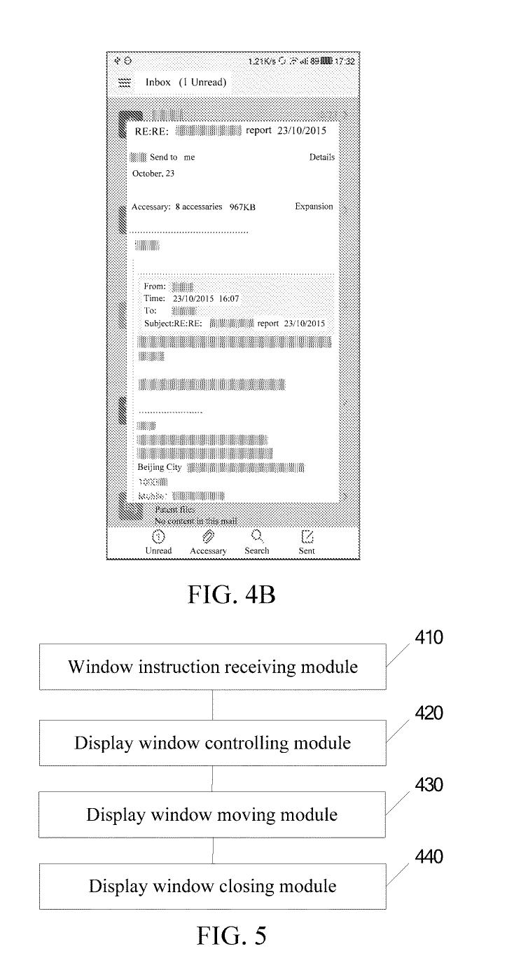

As shown in FIG. 5, which is a schematic diagram of an electronic device for controlling terminal window display according to Embodiment 4 of this application, the electronic device is used to perform the method for controlling terminal window display according to any one of the above-described embodiments, and configured in an intelligent terminal.

The electronic device for controlling terminal window display in this embodiment includes: a window instruction receiving module 410 and a display window controlling module 420.

The window instruction receiving module 410 is configured to receive an instruction to open a display window input by the user; and the display window controlling module 420 is configured to control the display window to be displayed in a floating manner according to a preset display size that is smaller than a size of the terminal screen, according to the instruction to open the display window.

Optionally, the display window controlling module 420 is configured to control the display window to be displayed in the center of the terminal screen in a floating manner according to the preset display size that is smaller than the size of the terminal screen.

Optionally, the controlling electronic device also includes: a display window moving module 430.

Particularly, after controlling the display window to be displayed in the floating manner according to the preset display size that is smaller than the size of the terminal full screen, the display window moving module 430 is configured to control the floatingly displayed window to move along a drag path, according to a user's drag operation instruction to the display window.

Optionally, the controlling electronic device also includes: a display window closing module 440.

Particularly, after controlling the display window to be displayed in the floating manner according to the preset display size that is smaller than the size of the terminal full screen, the display window closing module 440 is configured to control the display window to be closed, according to a user's triggering instruction input in a screen area other than the display window.

Optionally, the window instruction receiving module 410 is configured to receive the instruction to open a mail display window, where the instruction is input by clicking a mail entry on a mail list interface.

By adopting the electronic device for controlling terminal window display provided in Embodiment 4 of this application, after receiving an instruction to open the display window input by the user, the display window is controlled to be displayed in a floating manner according to a preset display size that is smaller than a size of the terminal screen, according to the instruction to open the display window. It can be seen that, a small-sized display window provides more operational convenience for the user, when the user views or operates the display window. For example, when the operating column of the display window is located at the top or the bottom of the display window, or the return button for returning to a previous display window is provided on the top or the bottom of the display window, compared with the related art, this embodiment has the advantages in that operations can be performed without moving the finger to the topmost of the terminal screen, therefore, the operating procedure is easy, and user experience is improved.

### Embodiment 5

Embodiment 5 of this application provides a non-transitory computer-readable storage medium storing executable instructions for performing any one of the above-described methods for controlling terminal window display in this application.

### Embodiment 6

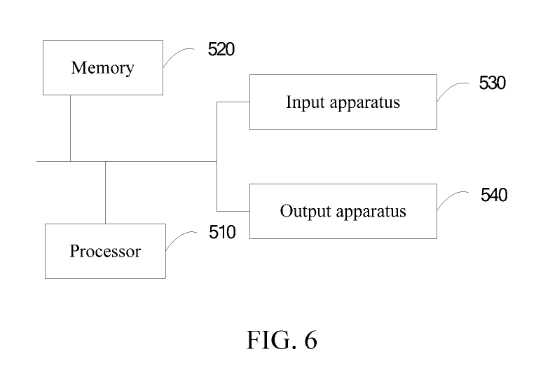

FIG. 6 is a hardware structural schematic diagram of a device for performing a method for controlling terminal window display according to Embodiment 6 of this application, as shown in FIG. 6, the device includes:

one or more processors 510 and a memory 520, for example, as shown in FIG. 6, one processor 510 is included in the device.

The device may also include: an input apparatus 530 and an output apparatus 540.

The processor 510, the memory 520, the input apparatus 530 and the output apparatus 540 can be connected via a bus or by other manners, for example, in FIG. 6, the processor 510, the memory 520, the input apparatus 530 and the output apparatus 540 are connected via a bus.

The memory 520, as a non-transitory computer-readable storage medium, can be used to store a non-transitory software program, a non-transitory executable program and modules, such as the program instruction/module (for example, the window instruction receiving module 410 and the display window controlling module 420 shown in FIG. 5) corresponding to the method for controlling terminal window display according to embodiments of this application. The processor 510 can perform various functional applications and data processing in the server by executing the non-transitory software program, instruction and module stored in the memory 520, that is, the method for controlling terminal window display according to the above method embodiment can be performed.

The memory 520 can include a storage program area and a storage data area, where, the storage program area can store an operating system and an application program required by at least one function; the storage data area can store data created by use of the electronic device for controlling terminal window display. Besides, the memory 520 can include a high-speed random access memory, and also a non-transitory memory, such as at least one magnetic disk storage device, flash memory device or other non-transitory solid state storage device. In some embodiments, the memory 520 optionally includes memories remotely located from the processor 510, and these remote memories can connect to the electronic device for controlling terminal window display through the network. Examples of the network include, but are not limited to, an Internet, an intranet, a local area network, a mobile communication network and combinations of the above mentioned networks.

The input apparatus 530 can receive the input figure or character information, generate key signal input associated with the user setting and functional control of the apparatus for controlling terminal window display. The output apparatus 540 can include a display device, such as a display screen.

One or more modules are stored in the memory 520, when the one or more processors 510 are executed, and the method for controlling terminal window display in any one of the above method embodiments is performed.

The above product can perform the method provided in the embodiments of this application, and have corresponding function modules and beneficial effects. Technical details which are not described in this embodiment can refer to the method provided in embodiments of this application.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for controlling terminal window display, comprising:
at an electronic device:
receiving an instruction to open a display window; and
controlling the display window to be displayed in a floating manner according to a preset display size that is smaller than a size of the terminal screen, according to the instruction to open the display window.

2. The method according to claim 1, wherein the controlling the display window to be displayed in a floating manner according to the preset display size that is smaller than the size of the terminal screen, according to the instruction to open the display window, comprises:
controlling the display window to be displayed in the center of the terminal screen in the floating manner according to the preset display size that is smaller than the size of the terminal screen.

3. The method according to claim 1, after controlling the display window to be displayed in a floating manner according to the preset display size that is smaller than the size of the terminal screen, the method further comprising: controlling a floatingly displayed window to move along a drag path, according to a drag operation instruction to the display window.

4. The method according to claim 1, after controlling the display window to be displayed in the floating manner according to the preset display size that is smaller than the size of the terminal screen, the method further comprising:
controlling the display window to be closed according to a triggering instruction input in a screen area other than the display window.

5. The method according to claim 1, wherein the receiving the instruction to open the display window, comprises:
receiving the instruction to open a mail display window, wherein the instruction is input by clicking a mail entry on a mail list interface.

6. An electronic device for controlling terminal window display, comprising:
at least one processor; and
a memory communicably connected with the at least one processor for storing instructions executable by the at least one processor, wherein execution of the instructions by the at least one processor causes the at least one processor to:
receive an instruction to open a display window; and
control the display window to be displayed in a floating manner according to a preset display size that is smaller than a size of the terminal screen, according to the instruction to open the display window.

7. The electronic device according to claim 6, wherein the execution of the instructions by the at least one processor causes the at least one processor to control the display window to be displayed in the center of the terminal screen in the floating manner according to the preset display size that is smaller than the size of the terminal screen.

8. The electronic device according to claim 6, wherein after controlling the display window to be displayed in a floating manner according to the preset display size that is smaller than the size of the terminal screen, the execution of the instructions by the at least one processor further causes the at least one processor to:
control a floatingly displayed window to move along a drag path, according to a drag operation instruction to the display window.

9. The electronic device according to claim 6, wherein after controlling the display window to be displayed in the floating manner according to the preset display size that is smaller than the size of the terminal screen, the execution of the instructions by the at least one processor further causes the at least one processor to:
control the display window to be closed, according to a triggering instruction input in a screen area other than the display window.

10. The electronic device according to claim 6, wherein the execution of the instructions by the at least one processor causes the at least one processor to:
receive the instruction to open a mail display window, wherein the instruction is input by clicking a mail entry on a mail list interface.

11. A non-transitory computer-readable storage medium storing executable instructions that, when executed by an electronic device, cause the electronic device to:
receive an instruction to open a display window; and
control the display window to be displayed in a floating manner according to a preset display size that is smaller than a size of the terminal screen, according to the instruction to open the display window.

12. The non-transitory computer-readable storage medium according to claim 11, wherein when controlling the display window to be displayed in a floating manner according to the preset display size that is smaller than the size of the terminal screen, according to the instruction to open the display window, the executable instructions cause the electronic device to:
control the display window to be displayed in the center of the terminal screen in the floating manner according to the preset display size that is smaller than the size of the terminal screen.

13. The non-transitory computer-readable storage medium according to claim 11, after controlling the display window to be displayed in a floating manner according to the preset display size that is smaller than the size of the terminal screen, the executable instructions further cause the electronic device to: control a floatingly displayed window to move along a drag path, according to a drag operation instruction to the display window.

14. The non-transitory computer-readable storage medium according to claim 11, after controlling the display window to be displayed in the floating manner according to the preset display size that is smaller than the size of the terminal screen, the executable instructions further cause the electronic device to:
control the display window to be closed according to a triggering instruction input in a screen area other than the display window.

15. The non-transitory computer-readable storage medium according to claim 11, wherein when receiving the instruction to open the display window, the executable instructions cause the electronic device to:
receive the instruction to open a mail display window, wherein the instruction is input by clicking a mail entry on a mail list interface.
